(19) United States
(12) Patent Application Publication
(10) Pub. No.: US 2008/0194714 A1
(43) Pub. Date: Aug. 14, 2008

(54) Method For Producing Workpieces

(75) Inventors: Christof Mock, Mannheim (DE); Gunnar Schornick, Neuleiningen (DE); Stefan Frenzel, Mannheim (DE); Moritz Ehrenstein, Ludwigshafen (DE); Andreas Fechtenkotter, Ludwigshafen (DE); Antje Ziemer, Mannheim (DE)

Correspondence Address: OBLON, SPIVAK, MCCLELLAND MAIER & NEUSTADT, P.C., 1940 DUKE STREET, ALEXANDRIA, VA, 22314, US

(73) Assignee: BASF Aktiengesellschaft, Ludwigshafen (DE)

(21) Appl. No.: 11/916,300

(22) PCT Filed: May 30, 2006
(86) PCT No.: PCT/EP06/62710

§ 371 Date: Dec. 3, 2007

(30) Foreign Application Priority Data
Jun. 2, 2005 (DE) 102005025794.1

(51) Int. Cl. C08J 9/35

(52) U.S. Cl. 521/51

(57) ABSTRACT

The present invention relates to a process for the production of workpieces, wherein
(a) pieces of open-cell aminoplast foam having an average diameter in the range from 50 μm to 5 mm (weight average)
(b) are mixed with at least one film-forming polymer,
   subjected to a shape-imparting step
   and then dried.

The present invention relates to a process for the production of workpieces, wherein
(a) pieces of open-cell aminoplast foam having an average diameter in the range from 50 μm to 5 mm (weight average)
(b) are mixed with at least one film-forming polymer,
   subjected to a shape-imparting step
   and then dried.

The present invention furthermore relates to workpieces produced by the process according to the invention. The present invention furthermore relates to the use of the workpieces according to the invention, for example as cleaning materials for cleaning surfaces.

Many cleaning materials, such as, for example, cleaning sponges and cleaning cloths, are produced from foams and are attracting growing economic interest. However, such cleaning materials are not yet free of disadvantages.

In the case of cleaning materials which are produced from foams, it is observed that, after a relatively short time of use, for example after about 10 minutes, they are destroyed to such an extent that a cleaning effect can no longer be achieved. Manufacturers of such cleaning materials, such as, for example, cleaning sponges, therefore recommend disposing of cleaning materials after an appropriate and generally very short time of use, for example 10 minutes. The dimensional stability is therefore still unsatisfactory in numerous cases.

It is furthermore observed that surfaces which were shiny in the clean state have a dull appearance after cleaning with many sponges sought by way of example.

There is however considerable interest also in cleaning originally shiny surfaces, such as, for example, cookers or so-called whiteboards (light, in particular white, writing boards, for example for offices) without such surfaces losing their shine.

EP 0 633 283 and DE 100 11 388 recommends reinforcing melamine resin foams by impregnating them, for example, with a silicone emulsion. Foams impregnated with silicone emulsion cannot, however, be used as cleaning materials since they leave behind streaks during use. DE 100 11 388 furthermore recommends spraying melamine resin foams with monomeric fluoroalkyl esters in order to make them oil-repellent.

A further major field of work relates to packaging materials, for example packaging chips and whole shaped articles which, for example, securely fix electrical appliances in cartons and protect them from impact and which can subsequently be easily removed during unpacking.

It was therefore the object to provide workpieces which avoid the above-described disadvantages known from the prior art. It was furthermore the object to provide processes for the production of workpieces. It was furthermore the object to provide uses for workpieces.

Accordingly, the process defined at the outset was found.

In the context of the present invention, workpieces are to be understood as meaning moldings of any desired dimensions, which may be rigid or flexible. Workpieces in the context of the present invention can be compressed by means of manual forces, in particular in the moistened state. Workpieces in the context of the present invention are preferably at least one centimeter long in at least two dimensions, or example in length and width.

Preferred examples of workpieces in the context of the present invention are, for example, cleaning materials, such as, for example, cleaning sponges and cleaning cloths, and furthermore building materials, insulating materials, sound insulating materials and packaging materials, such as, for example, packaging chips and shaped packaging articles.

The process according to the invention starts from pieces of open-cell aminoplast foam (a). Such pieces have an average diameter (weight average) in the range from 50 μm to 5 mm, preferably from 75 μm to 3 mm, particularly preferably from 100 μm to 2 mm.

Pieces of open-cell aminoplast foam (a) which are used in the process according to the invention may have a broad or a narrow diameter distribution. If the quotient of diameter (mass average) and diameter (number average) is calculated, the quotient may be, for example, in the range from 1.1 to 10, preferably from 1.2 to 3.

Pieces of open-cell aminoplast foam (a) used in the process according to the invention may have a regular or irregular shape. Examples of regular shapes are cubes, cuboids, spheres and ellipsoids. Examples of irregular shapes are granules, shreds and chips.

In an embodiment of the present invention, pieces of open-cell aminoplast foam (a) which are used in the process according to the invention are those based on synthetic organic foam, for example comprising urea/formaldehyde resins, in particular aminoplast foams based on aminoplast/formaldehyde resins, very particularly preferably melamine/formaldehyde resins, aminoplast foams based on melamine/formaldehyde resins also being referred to as melamine foams.

The process according to the invention is carried out starting from pieces of open-cell aminoplast foam (a) in which at least 50% of all lamellae are open, preferably from 60 to 100% and particularly preferably from 65 to 99.9%, determined according to DIN ISO 4590.

In an embodiment of the present invention, pieces of open-cell aminoplast foam (a) which are used in the process according to the invention comprise rigid aminoplast foam, i.e., in the context of the present invention, aminoplast foam which has a compressive strength of 1 kPa or more at a compressive strength of 40%, determined according to DIN 53577.

In an embodiment of the present invention, pieces of open-cell aminoplast foam (a) which are used in the process according to the invention comprise rigid aminoplast foam which has a density in the range from 5 to 500 kg m³, preferably from 6 to 300 kg/m³ and particularly preferably in the range from 7 to 300 kg/m³.

Pieces of open-cell aminoplast foam (a) which are used in the process according to the invention may have an average pore diameter (number average) in the range from 1 μm to 1 mm, preferably from 50 to 500 μm, determined by evaluating micrographs of sections.

In an embodiment of the present invention, pieces of open-cell aminoplast foam (a) which are used in the process according to the invention may comprise aminoplast foam which has not more than 20, preferably not more than 15 and particularly preferably not more than 10 pores per m² and which have a diameter in the range from up to 20 mm. The other pores usually have a smaller diameter.

In an embodiment of the present invention, pieces of open-cell aminoplast foam (a) which are used in the process according to the invention have a BET surface area in the range from 0.1 to 50 m²/g, preferably from 0.5 to 20 m²/g, determined according to DIN 66131.

In an embodiment of the present invention, pieces of open-cell aminoplast foam (a) which are used in the process according to the invention comprise aminoplast foam which has a sound absorption coefficient of more than 50%, measured according to DIN 52215 at a frequency of 2000 Hz and a layer thickness of the relevant foam (a) of 50 mm.

In a special embodiment of the present invention, pieces of open-cell aminoplast foam (a) which are used in the process according to the invention comprise aminoplast foam which has a sound absorption coefficient of more than 0.5, measured according to DIN 52212 at a frequency of 2000 Hz and a layer thickness of the relevant foam (a) of 40 mm.

Pieces of open-cell aminoplast foam (a) which are used in the process according to the invention can be obtained from aminoplast foam, for example by comminution. Suitable comminution methods are in particular mechanical comminution methods, such as, for example, pouring, punching, cutting, slicing, picking, sawing, milling, milling in an edge mill or shearing.

Particularly suitable apparatuses for the mechanical comminution of aminoplast foam are mills, cutters, chippers, graters, jaw crushers and mortars.

In an embodiment of the present invention, pieces of open-cell aminoplast foam (a) are produced from aminoplast foam having a density in the range from 5 to 500 kg/m³ and an average pore diameter in the range from 1 μm to 1 mm by mechanical comminution.

Melamine foams (a) particularly suitable as starting materials for carrying out the process according to the invention are known as such. They are prepared, for example, by foaming
i) a melamine/formaldehyde precondensate which, in addition to formaldehyde, may comprise further carbonyl compounds, such as, for example, aldehydes, incorporated in the form of condensed units, in the presence of
ii) one or more blowing agents,
iii) if appropriate, one or more emulsifiers,
iv) one or more curing agents.

Melamine/formaldehyde precondensates i) may be unmodified, but they may also be modified; for example, up to 20 mol % of the melamine may be replaced by other thermosetting thermoplastic precursors known per se, for example alkyl-substituted melamine, urea, urethane, carboxamides, dicyandiamide, guanidine, sulfurylamide, sulfonamides, aliphatic amines, phenol and phenol derivatives. Modified melamine/formaldehyde precondensates may comprise, for example, acetaldehyde, trimethylolacetaldehyde, acrolein, furfurol, glyoxal, phthaldialdehyde and terephthaldiadehyde incorporated in the form of condensed units as further carbonyl compounds in addition to formaldehyde.

The following are suitable as blowing agents ii): water, inert gases, in particular carbon dioxide, and so-called physical blowing agents. Physical blowing agents are compounds which are inert to the starting components and are preferably liquid at room temperature and evaporate under the conditions of the aminoplast formation. The boiling point of these compounds is preferably below 110° C., in particular below 80° C. The physical blowing agents also include inert gases which are introduced into the starting components i) and ii) or dissolved in them, for example carbon dioxide, nitrogen or noble gases.

Suitable compounds liquid at room temperature are selected from the group consisting of alkanes and/or cycloalkanes having at least 4 carbon atoms, dialkyl ethers, esters, ketones, acetals, fluoroalkanes having 1 to 8 carbon atoms and tetraalkylsilanes having 1 to 3 carbon atoms in the alkyl chain, in particular tetramethylsilane.

The following may be mentioned as examples: propane, n-butane, isobutane and cyclobutane, n-pentane, isopentane and cyclopentane, cyclohexane, dimethyl ether, methyl ethyl ether, methyl tert-butyl ether, methyl formate, acetone and fluorinated alkanes which can be degraded in the troposphere and therefore do not harm the ozone layer, such as trichloromethane, difluoromethane, 1,1,1,3,3-pentafluorobutane, 1,1,1,3,3-pentafluoropropane, 1,1,1,2-tetrafluoroethane, 1,1,1-trifluoro-2,2,2-trichloroethane, 1,1,2-trifluoro-1,2,2-trichloroethane, difluoroethanes and heptafluoropropane. Said physical blowing agents can be used alone or in any desired combinations with one another.

The use of perfluoroalkanes for producing fine cells is disclosed in EP-A 0 351 614.

Conventional nonionogenic, anionic, cationic or betaine surfactants can be used as emulsifiers iii), in particular C₁₂-C₃₀-alkanesulfonates, preferably C₁₂-C₁₈-alkanesulfonates and polyethoxylated C₁₀-C₂₀-alkyl alcohols, in particular of the formula R⁶—O(CH₂—CH₂—O)ₓ—H, where R⁶ is selected from C₁₀-C₂₀-alkyl and x may be, for example, an integer in the range from 5 to 100.

Particularly suitable curing agents iv) are acidic compounds, such as, for example, inorganic Brønsted acids, e.g. sulfuric acid or phosphoric acid, organic Brønsted acids, such as, for example, acetic acid or formic acid, Lewis acids and also so-called latent acids.

Examples of suitable melamine foams and processes for their preparation are to be found in EP-A 0 017 672.

Of course, aminoplast foam may comprise additives and compounding materials which are customary in foam chemistry, for example antioxidants, flameproofing agents, fillers, colorants, such as, for example, pigments or dyes, and biocides, for example

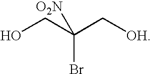

According to the invention, pieces of open-cell aminoplast foam are mixed with at least one film-forming polymer (b) which, in the context of the present invention, may comprise homopolymers and copolymers.

Film-forming polymer (b) can preferably be used as an aqueous dispersion or emulsion, for example having a solids content in the range from 1 to 90% by weight, preferably from 5 to 70% by weight, particularly preferably from 10 to 50% by weight.

In an embodiment of the present invention, film-forming polymer is a polymer having a minimum film formation temperature in the range from −30° C. to +70° C., preferably from −25° C. to 30° C., determined, for example, according to DIN 53787/ISO 2115.

In an embodiment of the present invention, film-forming polymer (b) is a (co)polymer of at least one ethylenically unsaturated mono- or dicarboxylic acid, for example crotonic acid, maleic acid, fumaric acid, metaconic acid, citraconic acid and in particular (meth)acrylic acid. A (co)polymer of at least one ethylenically unsaturated mono- or dicarboxylic acid may be partly or completely neutralized, for example with bases. Suitable bases are, for example, basic alkali metal salts, for example hydroxides or carbonates, such as, preferably, sodium hydroxide, sodium carbonate, potassium carbonate or potassium hydroxide. Further suitable bases are amines, unsubstituted or substituted by one to four identical or different organic radicals. Suitable organic radicals are, for example, phenyl,

C₁-C₁₀-alkyl, selected from methyl, ethyl, n-propyl, isopropyl, n-butyl, isobutyl, sec-butyl, tert-butyl, n-pentyl, isopentyl, sec-pentyl, neopentyl, 1,2-dimethylpropyl, isoamyl, n-hexyl, isohexyl, sec-hexyl, n-heptyl, iso-heptyl, n-octyl, n-nonyl, n-decyl, preferably linear C₁-C₆-alkyl, such as methyl, ethyl, n-propyl, n-butyl, n-pentyl, n-hexyl, isohexyl, sec-hexyl, particularly preferably C₁-C₄-alkyl, such as methyl, ethyl, n-propyl, n-butyl, very particularly preferably methyl and ethyl,

and ω-hydroxy-C₁-C₄-alkyl, for example 4-hydroxybutyl, 3-hydroxypropyl and in particular 2-hydroxyethyl.

Very particularly preferred amines are ammonia, diethylamine, triethylamine, diethanolamine, N-methyldiethanolamine, N-methylethanolamine, N-n-butyldiethanolamine, N-n-butylethanolamine, N,N-dimethylethanolamine and N,N-diethylethanolamine.

Film-forming polymers may be, for example, block copolymers, alternating copolymers and preferably random copolymers.

Film-forming polymers may have, for example, an average molecular weight M_{w} in the range from 1000 to 1 000 000 g/mol, preferably from 2000 to 250 000 g/mol.

Preferred film-forming polymers are, if appropriate, partly or completely neutralized
homopolymers of acrylic acid,
copolymers of (meth)acrylic acid with maleic acid, fumaric acid or C₁-C₁₀-alkyl (meth)acrylates,
copolymers of ethylene with (meth)acrylic acid or maleic acid and, if appropriate, one or more C₁-C₁₀-alkyl (meth)acrylates,
copolymers of styrene with (meth)acrylic acid or maleic acid or fumaric acid.

Particularly preferred film-forming polymers are, if appropriate, partly or completely neutralized
copolymers of (meth)acrylic acid with maleic acid or fumaric acid, having a monomer ratio of (meth)acrylic acid to maleic acid or fumaric acid in the range from 100:1 to 1:1, preferably from 10:1 to 50:50,
copolymers of (meth)acrylic acid with C₁-C₁₀-alkyl (meth)acrylate, having a monomer ratio of (meth)acrylic acid to C₁-C₁₀-alkyl (meth)acrylate in the range from 100:1 to 1:100, preferably from 10:1 to 1:10, particularly preferably from 3:1 to 1:3,
copolymers of ethylene with (meth)acrylic acid or maleic acid, having a molar ratio of ethylene to (meth)acrylic acid or maleic acid in the range from 100:1 to 3:1, preferably from 10:1 to 4:1,
copolymers of styrene with (meth)acrylic acid, having a monomer ratio of styrene to (meth)acrylic acid in the range from 100:1 to 1:100, preferably from 10:1 to 1:10, particularly preferably from 3:1 to 1:3,
copolymers of styrene with maleic acid or fumaric acid, having a monomer ratio of styrene to maleic acid or fumaric acid in the range from 100:1 to 1:1, preferably from 10:1 to 50:50.

The preparation of film-forming polymers is known per se and can be effected by any desired methods, for example of free radical polymerization or copolymerization of the corresponding monomers or comonomers. Film-forming polymer is then emulsified or dispersed, preferably in water. If film-forming polymer has been prepared, for example, by an emulsion polymerization method, the subsequent emulsification or dispersing can be dispensed with, and the emulsion and dispersion obtainable by the emulsion polymerization is used for carrying out the process according to the invention.

If it is desired to use a copolymer of ethylene and (meth)acrylic acid or maleic acid and, if appropriate, one or more C₁-C₁₀-alkyl (meth)acrylates or, if appropriate, further comonomers as a film-forming polymer, it is preferable to choose ethylene copolymers which comprise as comonomers incorporated in the form of polymerized units:

(A) from 60 to 95% by weight, preferably from 65 to 85% by weight, of ethylene and (B) from 5 to 40% by weight, preferably from 15 to 35% by weight, of (meth)acrylic acid or maleic acid, particularly preferably (meth)acrylic acid, data in % by weight being based on total film-forming polymer (b).

Ethylene copolymers used according to the invention as film-forming polymer (b) may comprise up to 40% by weight, preferably up to 35% by weight, based in each case on the sum of ethylene and (meth)acrylic acid or maleic acid incorporated in the form of polymerized units, of one or more further comonomers (C) incorporated in the form of polymerized units, for example

vinyl, allyl and methallyl esters of C₁-C₁₀alkylcarboxylic acids or of formic acid, for example vinyl formate, vinyl propionate and in particular vinyl acetate,

one or more C₁-C₁₀-alkyl (meth)acrylates, in particular methyl acrylate, methyl methacrylate, ethyl acrylate, ethyl methacrylate, n-butyl acrylate, n-butyl methacrylate, 2-ethylhexyl acrylate, 2-ethylhexyl methacrylate,

furthermore vinylaromatic compounds, such as, for example, α-methylstyrene and in particular styrene,

isobutene and

α-olefins, such as, for example, CH₂═CH-n-C₁₆H₃₃,CH₂═CH-n-C₁₈H₃₇, CH₂═CH-n-C₂₀H₄₁ and CH₂═CH-n-C₂₂H₄₅

Ethylene copolymers of ethylene and (meth)acrylic acid or maleic acid, and, if appropriate, one or more C₁-C₁₀-alkyl (meth)acrylates or, if appropriate, further comonomers, which are described above, can advantageously be prepared by free radical copolymerization under high pressure conditions, for example in stirred high-pressure autoclaves or in high-pressure tubular reactors. The preparation in stirred high-pressure autoclaves is preferred. Stirred high-pressure autoclaves are known per se, and a description is to be found in Ullmann's Encyclopedia of Industrial Chemistry, 5th Edition, key words: Waxes, Vol. A 28, page 146 et seq., Verlag Chemie Weinheim, Basle, Cambridge, N.Y., Tokyo, 1996. Their length/diameter ratio is predominantly in the ranges from 5:1 to 30:1, preferably from 10:1 to 20:1. The high-pressure tubular reactors which may also be used are likewise described in Ullmann's Encyclopedia of Industrial Chemistry, 5th Edition, key words: Waxes, Vol. A 28, page 146 et seq., Verlag Chemie Weinheim, Basle, Cambridge, N.Y., Tokyo, 1996.

Suitable pressure conditions for the polymerization are from 500 to 4000 bar, preferably from 1500 to 2500 bar. The reaction temperatures are in the range from 170 to 300° C., preferably in the range from 200 to 280° C.

The copolymerization can be carried out in the presence of a regulator. For example, hydrogen or an aliphatic aldehyde or an aliphatic ketone or a mixture thereof is used as a regulator, propionaldehyde, methyl ethyl ketone and diethyl ketone are preferred.

Other suitable regulators are alkylaromatic compounds, for example toluene, ethylbenzene or one or more isomers of xylene. It is preferable to dispense with the use of aldehydes and ketones as regulators. Particularly preferably, no further regulators are metered, with the exception of so-called desensitizers, which can be added for better handling to organic peroxides and may likewise have the function of a molecular weight regulator.

The conventional free radical initiators, such as, for example, organic peroxides, oxygen or azo compounds, can be used as initiators for the free radical polymerization. Mixtures of a plurality of free radical initiators are also suitable.

Suitable peroxides selected from the commercially available substances are, for example,
didecanoyl peroxide, 2,5-dimethyl-2,5-di(2-ethylhexanoylperoxy)hexane, tert-amylperoxy 2-ethylhexanoate, dibenzoyl peroxide, tert-butyl peroxy-2-ethylhexanoate, tert-butyl peroxydiethylacetate, tert-butyl peroxydiethylisobutyrate, 1,4-di(tert-butyl-peroxycarbonyl)cyclohexane as an isomer mixture, tert-butyl perisononanoate 1,1-di-(tert-butylperoxy)-3,3,5-trimethylcyclohexane, 1,1-di-(tert-butylperoxy)cyclohexane, tert-amyl peroxypivalate, methyl isobutyl ketone peroxide, tert-butyl peroxyisopropyl carbonate, 2,2-di-(tert-butylperoxy)butane or tert-butylperoxyacetate;
tert-butyl peroxybenzoate, di-tert-amyl peroxide, dicumyl peroxide, the isomeric di-(tert-butylperoxyisopropyl)benzene, 2,5-dimethyl-2,5-di-tert-butylperoxyhexane, tert-butyl cumyl peroxide, 2,5-dimethyl-2,5-di(tert-butylperoxy)hex-3-yne, di-tert-butyl peroxide, 1,3-diisopropylbenzene monohydroperoxide, cumyl hydroproxide or tert-butyl hydroperoxide; or
dimeric or trimeric ketone peroxides, as disclosed in EP-A 0 813 550.

Particularly suitable peroxides are di-tert-butyl peroxide, tert-butyl peroxypivalate, tert-butyl peroxyisononanoate or dibenzoyl peroxide or mixtures thereof. Azobisisobutyronitrile (AIBN) may be mentioned by way of example as an azo compound. Free radical initiators are metered in amounts customary for polymerizations.

The ratio of the comonomers ethylene and ethylenically unsaturated carboxylic acid(s) in the metering usually does not correspond exactly to the ratio of the units in film-forming polymer (b) used according to the invention, because ethylenically unsaturated carboxylic acids are generally more readily incorporated than ethylene.

Ethylene copolymers prepared as described above can be converted, for example, into aqueous dispersions by neutralizing them in the molten state partly or preferably completely with an aqueous base, suitable bases being mentioned above.

For carrying out the process according to the invention, pieces of open-cell aminoplast foam (a) and film-forming polymer (b) are mixed. The mixing is usually effected in the presence of water.

Suitable apparatuses for mixing pieces of open-cell aminoplast foam (a) and film-forming polymer (b) are any desired vessels, such as, for example, stirred vessels, and furthermore extruders.

In an embodiment of the present invention, pieces of open-cell aminoplast foam (a) and film-forming polymer (b) are mixed in a weight ratio in the range from 70:30 to 10:90, preferably from 60:40 to 20:80, the weight ratios being based in each case on the solid.

By mixing pieces of open-cell aminoplast foam (a) and film-forming polymer (b), a material which may have, for example, low viscosity and a pulpy to pasty consistency is obtained.

In an embodiment of the present invention, material used according to the invention and comprising pieces of open-cell aminoplast foam (a) and film-forming polymer (b) has a dynamic viscosity of from more than 50 to 2000 dPa·s, determined at 23° C., preferably in the range from 60 to 1800 dPa·s and particularly preferably at least 100 dPa·s. Dynamic viscosities can be determined, for example, using a Brookfield viscometer.

In an embodiment of the present invention, material used according to the invention and comprising pieces of open-cell aminoplast foam (a) and film-forming polymer (b) has a solids content in the range from 5 to 95% by weight, preferably from 10 to 80% by weight.

For carrying out the process according to the invention, the material is obtained as described above and comprising pieces of open-cell aminoplast foam (a) and film-forming polymer (b) is subjected to a shape-imparting step. For example, the material obtained as described above and comprising pieces of open-cell aminoplast foam (a) and film-forming polymer (b) can be poured, injection molded or applied with the aid of an article. For the shaping, the material obtained as described above and comprising pieces of open-cell aminoplast foam (a) and film-forming polymer (b) can be added to a shape-imparting vessel or introduced into a die or into a plurality of dies. Examples of suitable dies are molds, templates or dishes of any desired materials. Suitable molds are in the form of negatives of the workpiece to be produced.

Suitable dies may comprise, for example, glass, ceramics or metal, preferably an alloy, in particular steel or a plastic, such as, for example, polyamide, polyethylene or polypropylene.

In order to ensure a smooth surface, the material introduced into a mold can be smoothed using a tool.

After the material comprising pieces of open-cell aminoplast foam (a) and film-forming polymer (b) has been subjected to a shape-imparting step, drying is effected.

Drying can be effected at a temperature which is below the decomposition temperature of film-forming polymer (b). Temperatures in the range from 20 to 120° C. are generally preferred.

In an embodiment of the present invention, the process according to the invention is carried out by a procedure in which drying is effected in a gas stream, for example by passing a stream of gas, preferably inert gas, such as, for example, nitrogen or noble gas, or air, over the mold filled with material comprising pieces of open-cell aminoplast foam (a) and film-forming polymer (b).

In an embodiment of the present invention, the process according to the invention is carried out by a procedure in which drying is effected in vacuo or under reduced pressure, for example with simultaneous heating or at room temperature.

In an embodiment of the present invention, the process according to the invention is carried out by a procedure in which drying is effected in the air or in a through-circulation drying oven.

For example, drying can be effected over a period of from 1 hour to 24 hours.

In an embodiment of the present invention, the process according to the invention is carried out by a procedure in which drying is effected in vacuo or in a gas stream or under reduced pressure until the preformed workpiece has sufficient mechanical strength, and drying is then effected in the air.

In an embodiment of the present invention, the preformed workpiece is removed from the mold during the drying and is turned. The drying can then be continued. In this embodiment, the duration of the drying is generally shortened.

After the process according to the invention has been carried out, the workpiece obtained is demolded, i.e. it is removed from the die. The demolding can be effected manually or automatically.

In an embodiment of the present invention, one or more additives are added to the material comprising pieces of open-cell aminoplast foam (a) and film-forming polymer (b). Suitable additives are, for example, dyes, organic or inorganic pigments, metal turnings, biocides, odor inhibitors and plasticizers.

Examples of particularly suitable plasticizers are ester compounds selected from the groups consisting of the aliphatic or aromatic di- or polycarboxylic acids completely esterified with C₁-C₁₀-alkanol and of phosphoric acid at least monoesterified with alkanol

Preferred examples of aromatic di- or polycarboxylic acids completely esterified with C₁-C₁₀-alkanol are phthalic acid, isophthalic acid and mellitic acid completely esterified with alkanol; the following may be mentioned by way of example: di-n-octyl phthalate, di-n-nonyl phthalate, di-n-decyl phthalate, di-n-octyl isophthalate, di-n-nonyl isophthalate and di-n-decyl isophthalate.

Preferred examples of aliphatic di- or polycarboxylic acids completely esterified with C₁-C₁₀-alkanol are, for example, dimethyl adipate, diethyl adipate, di-n-butyl adipate, diisobutyl adipate, dimethyl glutarate, diethyl glutarate, di-n-butyl glutarate, diisobutyl glutarate, dimethyl succinate, diethyl succinate, di-n-butyl succinate, diisobutyl succinate and mixtures of the abovementioned compounds.

Preferred examples of phosphoric acid at least monoesterified with C₁-C₁₀-alkanol are C₁-C₁₀-alkyl di-C₆-C₁₄-aryl phosphates, such as isodecyl diphenyl phosphate.

Further suitable examples of plasticizers are aliphatic or aromatic di- or polyols at least monoesterified with C₁-C₁₀-alkyl carboxylic acid.

A preferred example of aliphatic or aromatic di- or polyols at least monoesterified with C₁-C₁₀-alkylcarboxylic acid is 2,2,4-trimethylpentane-1,3-diol monoisobutyrate.

Further suitable plasticizers are polyesters, obtainable by polycondensation of aliphatic dicarboxylic acid and aliphatic diol, for example adipic acid or succinic acid and 1,2-propanediol, preferably having an M_{w} of 200 g/mol, and polypropylene glycol alkylphenyl ether, preferably having an M_{w} of 450 g/mol.

Further suitable plasticizers are polypropylene glycols etherified with two different alcohols and having a molecular weight M_{w} in the range from 400 to 800 g/mol, it being preferable for one of the alcohols to be an alkanol, in particular a C₁-C₁₀-alkanol, and for the other alcohol preferably to be an aromatic alcohol, for example, o-cresol, m-cresol, p-cresol and in particular phenol.

Of course, dies, such as, for example, molds, templates or dishes can be prepared prior to carrying out the shape-imparting step, for example can be pretreated with one or more silicones as an adhesive or with one or more wax emulsions as a mold release agent.

The present invention furthermore relates to workpieces produced by the process according to the invention. Workpieces according to the invention may have any desired shapes. Workpieces according to the invention can be readily used for cleaning surfaces for example, and furthermore as packaging material or as building materials, insulating materials or sound insulating materials.

Workpieces according to the invention can be readily written on and printed on, for example by the inkjet method.

The present invention furthermore relates to the use of workpieces according to the invention as cleaning materials for cleaning surfaces. The present invention furthermore relates to a method for cleaning surfaces using workpieces according to the invention as cleaning materials, also referred to below as cleaning methods according to the invention.

Cleaning materials according to the invention may be in any desired forms, for example in the form of cleaning cloths, rags or cleaning sponges. Cleaning materials according to the invention can also be firmly connected to a rigid base, for example a substrate, to form composites according to the invention, or may be provided with one or more handles, for example of plastic, wherein such composites according to the invention can be used for cleaning surfaces.

When carrying out the cleaning method according to the invention, structured or preferably smooth shiny surfaces are cleaned to remove impurities comprising at least one substance which is selected from

fats, oils, waxes, for example polyethylene waxes, paraffin waxes, liquid paraffins, ester oils, natural oils and fats, lubricating greases, bearing greases, Stauffer greases, montan waxes,

metal salts of anionic surfactants, such as, for example, lime soap, biofilms, for example mold or Pseudomonas biofilms, polymers, for example paint splashes, polyurethane foam, silicones (polysiloxanes), metal oxides, for example copper, lead or nickel oxide, or rust formed, for example, as a result of corrosion, or rust particles or rust film, in particular iron oxides, metal hydroxides and metal carbonates, which may be neutral, acidic or basic, in particular iron, copper or nickel hydroxide, aluminum hydroxide, magnesium hydroxide, MgCO₃, basic MgCO₃, CaCO₃, it being possible for metal oxides, metal carbonates and metal hydroxides to have been formed by corrosion from the base metal of the structured surface, for example of a die or workpiece, or to have been deposited in a secondary process,

residues of lubricants, for example partially coked or partially or completely resinified lubricants, and broken emulsions. The following may be mentioned by way of example: resinified natural ester oils on, for example, chain saws or coked oils on hotplates of polyester filament spinning mills,

inscriptions or paintings with oil-based or water-based colored pens.

Impurities may be distributed uniformly or nonuniformly on surfaces to be cleaned, for example in the form of spots, rims or splashes, or as film.

For carrying out the cleaning method according to the invention, one or more workpieces according to the invention are passed once or preferably several times over the surface to be cleaned. The contact pressure can be chosen as desired. One or more workpieces according to the invention can be passed manually or mechanically over the surface to be cleaned.

For carrying out the cleaning method according to the invention, one or more workpieces according to the invention can be used in a form moistened with, for example, water or preferably in dry form.

It is observed that, by means of the cleaning method according to the invention, impurities can be very readily removed and in particular smooth shiny surfaces are not scratched or not significantly scratched.

The present invention furthermore relates to the use of workpieces according to the invention as or for the production of packaging material.

In the context of the present invention, packaging chips and shaped articles which protect goods to be packed in, for example, cartons or crates from impacts and/or displacement/slipping may be mentioned in particular as packaging material. When used as packaging material, workpieces according to the invention are not only advantageous in the application but can also be easily removed.

The invention is explained by working examples.

### WORKING EXAMPLES

I.1 Preparation of Aminoplast Foam (a.1)

In an open vessel, a spray-dried melamine/formaldehyde precondensate (molar ratio 1:3, molecular weight about 500 g/mol) was added to an aqueous solution comprising 3% by weight of formic acid and 1.5% by weight of the sodium salt of a mixture of alkanesulfonates having 12 to 18 carbon atoms in the alkyl radical (emulsifier K 30 from Bayer AG), the percentages being based on melamine/formaldehyde precondensate. The concentration of the melamine/formaldehyde precondensate, based on the total mixture of melamine/formaldehyde precondensate and water, was 74% by weight. The mixture thus obtainable was vigorously stirred, after which 20% by weight of n-pentane were added. Stirring was continued (for about 3 min) until a dispersion having a homogeneous appearance formed. This was applied to a Teflon-coated glass fabric as substrate material by knife coating and foamed and cured in a drying oven in which an air temperature of 150° C. prevailed. The boiling point of the n-pentane, which is at 37.0° C. under these conditions, resulted as the material temperature in the foam. After from 7 to 8 min, the maximum rise height of the foam had been reached. The foam was left for a further 10 min at 150° C. in the drying oven; it was then annealed for 30 min at 180° C. Unmodified foam (a.1) was obtained.

The following properties were determined for the unmodified foam (a.1):

99.6% open-cell character according to DIN ISO 4590,

compressive strength (40%) 1.3 kPa, determined according to DIN 53577,

density 7.6 kg/m³, determined according to EN ISO 845,

average pore diameter 210 μm, determined by evaluating micrographs of sections,

BET surface area of 6.4 m²/g, determined according to DIN 66131,

sound absorption coefficient of 93%, determined according to DIN 52215,

sound absorption coefficient of more than 0.9, determined according to DIN 52212.

I.2 Production of Pieces of Aminoplast Foam by Milling

A cuboid of aminoplast foam (a.1) was milled with the aid of a laboratory analytical mill (type A10) operated with the aid of guillotine knives and then sieved over a vibrating sieve of mesh size 250 μm. Pieces of aminoplast foam having an average diameter of up to 250 μm were obtained. The sieve residue was discarded.

II. Preparation of a Film-Forming Polymer (b.1) in Dispersed Form

II.1. Preparation of a Film-Forming Polymer (b.1) of Ethylene and Methacrylic Acid

Ethylene and methacrylic acid were copolymerized in a high pressure autoclave as described in the literature (M. Buback et al., Chem. Ing. Tech. 1994, 66, 510). For this purpose, ethylene (12.3 kg/h) was fed into the autoclaves under the reaction pressure of 1700 bar. Separately therefrom, 1.04 l/h of methacrylic acid were first compressed to an intermediate pressure of 260 bar and then fed in under the reaction pressure of 1700 bar. Separately therefrom, 2 l/h of an initiator solution consisting of tert-amyl peroxypivalate (0.13 mol·l⁻¹ in isododecane) were fed into the autoclaves under the reaction pressure of 1700 bar. The reaction temperature was 220° C. 3.4 kg/h of film-forming polymer (b.1) having the following properties were obtained: 26.2% by weight of methacrylic acid, 73.8% by weight of ethylene, melting range 75-85° C., measured according to DIN 51007, p 0.9613 g/cm³, MFI 10.5 g/10 min, measured at 120° C. and under a load of 325 g according to DIN 53735, acid number 170.5 mg KOH/g (determined according to ES ISO 3682).

The content of ethylene and methacrylic acid in the film-forming polymer (b.1) was determined by NMR spectroscopy and by titration (acid number). The acid number of the film-forming polymer (b.1) was determined titrimetrically according to DIN 53402. The KOH consumption corresponds to the methacrylic acid content in the film-forming polymer (b.1).

II.2. Preparation of an Aqueous Dispersion of Film-Forming Polymer (b.1)

II.2.1 Preparation of an Aqueous Dispersion D1

250 g of film-forming polymer (b.1) according to example II.1, 34 g of 25% by weight aqueous ammonia solution and 716 ml of demineralized water were initially taken in a 2 liter stirred kettle having an anchor stirrer and reflux condenser. Heating to 95° C. was effected with stirring, and stirring was continued for three hours at 95° C. Aqueous dispersion D1 having a pH of 8.5 was obtained. The solids content of D1 was 25.3% by weight.

II.2.2 Preparation of an Aqueous Dispersion D2

206.8 g of film-forming polymer (b.1) according to example II.1, 34.9 g of N,N-dimethylethanolamine and 758.3 ml of demineralized water were initially taken in a 2 liter stirred kettle having an anchor stirrer and reflux condenser. Heating to 95° C. was effected with stirring, and stirring was continued for three hours at 95° C. Aqueous dispersion D2 having a pH of 8.5 was obtained. The solids content of D2 was 21% by weight.

III. Production of Workpieces According to the Invention (General Method 1)

III.1 Production of Workpieces According to the Invention (General Method 1)

Aqueous dispersion D1 or D2 according to table 1 was initially taken in a 1 l stirred vessel. Stirring was effected at a speed of 600 rpm, and the amount of pieces of aminoplast foam according to example I.2 and stated in table 1 was added. Stirring was effected for a further 10 minutes at 600 rpm, and a pulpy material was obtained. The pulpy material thus obtained was introduced into a ceramic dish (internal dimensions 10·20 cm) and the latter was transferred to a vacuum drying oven. Drying was effected at 110° C./150 mbar over a period of six hours. Thereafter, the workpiece forming was removed from the mold, turned, and dried at 110° C. in an N₂ stream over a period of a further three hours. Drying was then effected for a further 12 hours at room temperature and 150 mbar in an N₂ stream. A workpiece according to the invention, as shown in table 1, was obtained.

III.2 Production of Workpieces According to the Invention (General Method 2)

Aqueous dispersion D1 or D2 according to table 1 was initially taken in a 1 l stirred vessel. Stirring was effected at a speed of 600 rpm, and the amount of pieces of aminoplast foam according to example I.2 and stated in table 1 was added. Stirring was effected for a further 10 minutes at 600 rpm, and a pulpy material was obtained. The pulpy material thus obtained was introduced into a ceramic dish (internal dimensions 10·20 cm) and the latter was transferred to a through-circulation drying oven. Drying was effected at 110° C. in an N₂ stream over a period of three hours. Thereafter, the workpiece forming was removed from the mold, turned, and dried at 110° C. in an N₂ stream over a period of a further three hours. Drying was then effected for a further 12 hours at room temperature and 150 mbar in an N₂ stream. A workpiece according to the invention, as shown in table 1, was obtained.

TABLE 1
Production of workpieces according to the invention

| | |
|---|---|
| Amount of | [g] |
| pieces of (a.1) | Dispersion |

| Number | [g] | D1 | D2 | Drying |
|---|---|---|---|---|
| W1 | 30 | 200 | | Vacuum |
| W2 | 50 | | 200 | Vacuum |
| W3 | 50 | | 200 | Circulation |
| W4 | 60 | 200 | | Circulation |

Remark:
Vacuum represents vacuum drying oven, circulation represents through-circulation drying oven.

IV. Cleaning Method According to the Invention

A whiteboard was first written on with a red felt pen. Thereafter, workpiece W1 was taken and was passed twice in the dry state over the dry whiteboard without pressing down firmly. The inscription was completely removed. W1 could be easily and completely cleaned without additives. The whiteboard was not scratched but retained its shiny surface.

The cleaning method as described above could be carried out in each case in an analogous manner with the workpieces W2 to W4 according to the invention with likewise very good results.

1. A process for the production of workpieces, wherein
(a) pieces of an open-cell aminoplast foam having an average diameter in the range from 50 μm to 5 mm (weight average)
(b) are mixed with at least one film-forming polymer, subjected to a shape-imparting step and then dried.

2. The process according to claim 1, wherein the pieces of the open-cell aminoplast foam (a) are produced from an aminoplast foam having a density in the range from 5 to 500 kg/m³ and an average pore diameter in the range from 1 μm to 1 mm by mechanical comminution.

3. The process according to claim 1, wherein the film-forming polymer is a polymer having a minimum film formation temperature in the range from 30° C. to +50° C.

4. The process according to claim 1, wherein the film-forming polymer (b) is a (co)polymer of (meth)acrylic acid.

5. The process according to claim 1, wherein the shape-imparting step is selected from casting and injection molding of a mixture of pieces of the open-cell aminoplast foam (a) and the film-forming polymer (b).

6. The process according to claim 1, wherein the workpiece is removed from the mold and turned during drying.

7. The process according to claim 1, wherein drying is effected at temperatures in the range from 20 to 120° C.

8. A workpiece obtainable by a process according to claim 1.

9. (canceled)

10. A method for cleaning surfaces using workpieces according to claim 8 as cleaning materials.

11. (canceled)
